(19) United States
(12) Patent Application Publication
(10) Pub. No.: US 2011/0006963 A1
(43) Pub. Date: Jan. 13, 2011

(54) ANTENNA ELEMENT

(75) Inventors: Kazuya Tani, Osaka (JP); Yoshio Koyanagi, Kanagawa (JP); Toshiteru Hayashi, Kanagawa (JP)

Correspondence Address: Seed Intellectual Property Law Group PLLC, 701 Fifth Avenue, Suite 5400, Seattle, WA, 98104, US

(73) Assignee: PANASONIC CORPORATION, Osaka (JP)

(21) Appl. No.: 12/922,120

(22) PCT Filed: Dec. 24, 2008
(86) PCT No.: PCT/JP2008/003938

§ 371 Date: Sep. 10, 2010

(30) Foreign Application Priority Data
Mar. 11, 2008 (JP) 2008-061307

(51) Int. Cl. H01Q 9/04; H01Q 1/00

(52) U.S. Cl. 343/787; 343/700 MS

(57) ABSTRACT

An antenna element includes: a first conductive plate which is approximately rectangular; a second conductive plate which shares one side of the first conductive plate in the width direction, which is placed substantially perpendicularly to the first conductive plate, and which is approximately rectangular; a third conductive plate which shares another side of the second conductive plate in the width direction, the other side being opposed to the one side shared with the first conductive plate, which is placed perpendicularly to be opposed to the first conductive plate, and which is approximately rectangular; a fourth conductive plate which shares one sides of the first conductive plate, the second conductive plate, and the third conductive plate; a sixth conductive plate which extends from one side of the fourth conductive plate that does not share one sides of the first conductive plate, the second conductive plate, and the third conductive plate, and which is placed substantially perpendicularly to the fourth conductive plate; slits which are disposed respectively between the sixth conductive plate, and the first conductive plate and the third conductive plate; a short pin which connects the ground plate to the first conductive plate or the second conductive plate; and a feed pin which is connected to the first conductive plate or the second conductive plate in parallel to the short pin and in adjacent to the short pin.

### TECHNICAL FIELD

The present invention relates to an antenna element which can cope with wideband and multiband transmission.

### BACKGROUND ART

Recently, a request for adding functions of a plurality of radio systems such as GPS and Bluetooth (registered trademark) to a portable radio device (such as a portable telephone) is increasing. When a plurality of radio systems are to be disposed in a portable telephone, the frequency band to be used is wider, and the portable telephone must cope with the 1.5 GHz band for GPS and the 2.4 GHz band for Bluetooth in addition to, for example, three bands of the 800 MHz band, the 1.7 GHz band, and 2 GHz band which are used in communication between portable telephones. When a plurality of radio systems is to be disposed in a portable telephone, therefore, a built-in antenna must ensure predetermined antenna performance with respect to a plurality of frequency bands.

FIG. 24 is a perspective view of a rectangular parallelepiped antenna element which is disclosed in Patent Reference 1. The antenna element shown in FIG. 24 is a three-dimensionally shaped antenna element that has first and second faces which are opposed to each other, and a third face through which the two faces are coupled to each other, and includes a core 1 which is smaller as compared with the operating wavelength, and which is made of a dielectric material, and conductive thin films 2₁ to 2₃ which are formed on the first to third faces, respectively. Because of the shape of the antenna element, an effect in which the wavelength is further shortened by a fraction is obtained in addition to the wavelength shortening due to the dielectric material.

FIG. 25 is an external view showing an antenna in which an antenna element of Patent Reference 2 is formed. In the antenna shown in FIG. 25, a bended dipole antenna 32 one end of which is connected to a feeding terminal 31, and the other end of which is connected to a grounding terminal 36 is formed on the surface of an antenna chip 20, one end of a monopole antenna 41 is connected to the bended dipole antenna 32, and the monopole antenna 41 is formed on the back and side faces of the antenna chip 20. The antenna shown FIG. 25 includes the dipole antenna 32 and the monopole antenna 41. Therefore, the antenna has multiband characteristics.

FIG. 26 has a view abstractly showing the structure of an antenna of Patent Reference 3. The antenna shown in FIG. 26 is an inverted F antenna configured by a planar conductive plate, and a tip end portion is bent two times toward a conductive ground plate 303 to configure two faces in which an open end is adjacent to the conductive ground plate 303. Therefore, a capacitor is formed between the tip end portion and the conductive ground plate 303, and both the lowering of the resonant frequency and wider bandwidth are attained.

Patent Reference 1: JP-A-8-084013

Patent Reference 2: JP-A-2006-246070

Patent Reference 3: JP-A-2002-223114

### DISCLOSURE OF THE INVENTION

### Problems that the Invention is to Solve

In order to cause the antenna element disclosed in Patent Reference 1 to cope with a low frequency band, the size of the antenna element must be increased. In order to cause the antenna element to cope with multiband transmission, furthermore, a plurality of antenna elements is required, and therefore the mounting volume becomes large.

The antenna chip disclosed in Patent Reference 2 is effective in attaining multiband transmission, but has problems in further miniaturization of the antenna element and wider bandwidth. The planar inverted F antenna disclosed in Patent Reference 3 requires the conductive ground plate 11 below the antenna element. In order to realize wideband, the distance with respect to the conductive ground plate 11 must be about 7 mm, and hence the antenna is not suitable for a thin electronic apparatus such as a portable telephone.

The invention has been conducted in view of the above-discussed circumstances. It is an object of the invention to provide an antenna element which is small, which produces a high gain, in which the band can be wider, and which can cope with multiband transmission.

### Means for Solving the Problems

The invention provides an antenna element comprising: a first conductive plate which is placed with being separated from a ground plate by a predetermined interval, and which is approximately rectangular; a second conductive plate which shares one side of the first conductive plate in a width direction, which is placed at about 90 degrees with respect to the first conductive plate, and which is approximately rectangular; a third conductive plate which shares another side of the second conductive plate in the width direction, the another side being opposed to the one side shared with the first conductive plate, which is placed at about 90 degrees so as to be opposed to the first conductive plate, and which is approximately rectangular; a fourth conductive plate which shares one sides of the first conductive plate, the second conductive plate, and the third conductive plate; a sixth conductive plate which extends from one side of the fourth conductive plate that does not share the one sides of the first conductive plate, the second conductive plate, and the third conductive plate, and which is placed at about 90 degrees with respect to the fourth conductive plate; slits which are disposed respectively between the sixth conductive plate, and the first conductive plate and the third conductive plate; a short pin which connects the ground plate to the first conductive plate or the second conductive plate; and a feed pin which is connected to the first conductive plate or the second conductive plate in parallel to the short pin and in adjacent to the short pin.

The antenna element includes: a fifth conductive plate which is placed at a position opposed to the fourth conductive plate across the first conductive plate, the second conductive plate, and the third conductive plate, and which shares one sides of the first conductive plate, the second conductive plate, and the third conductive plate; a ninth conductive plate which extends from one side of the fifth conductive plate that does not share the one sides of the first conductive plate, the second conductive plate, and the third conductive plate, and which is placed at about 90 degrees with respect to the fifth conductive plate; and slits which are disposed respectively between the ninth conductive plate, and the first conductive plate and the third conductive plate.

In the antenna element, the short pin and the feed pin are connected to the first conductive plate or the second conductive plate in a substantially middle in a width direction of the first conductive plate or the second conductive plate.

In the antenna element, the short pin and the feed pin are rectangular thin plates, and a length of one side in the width direction of the first conductive plate or the second conductive plate is equal to or smaller than a total of a width of the short pin, an interval between the short pin and the feed pin, and a width of the feed pin.

In the antenna element, the width of the short pin is equal to the width of the feed pin.

In the antenna element, the sixth conductive plate is formed into a meander shape by a strip line.

In the antenna element, the ninth conductive plate is formed into a meander shape by a strip line.

In the antenna element, a space formed by the first conductive plate, the second conductive plate, the third conductive plate, and the fourth conductive plate is filled with a dielectric material or a magnetic material.

The invention provides an antenna element comprising: a first conductive plate which is placed with being separated from a ground plate by a predetermined interval, and which is approximately rectangular; a second conductive plate which shares one side of the first conductive plate in a width direction, which is placed at about 90 degrees with respect to the first conductive plate, and which is approximately rectangular; a fourth conductive plate which shares one sides of the first conductive plate and the second conductive plate; a sixth conductive plate and seventh conductive plate which extend respectively from two adjacent sides of the fourth conductive plate that do not share the one sides of the first conductive plate and the second conductive plate, and which are placed at about 90 degrees with respect to the fourth conductive plate; slits which are disposed respectively between the sixth conductive plate and the seventh conductive plate, and the first conductive plate and the second conductive plate; a short pin which connects the ground plate to the first conductive plate or the second conductive plate; and a feed pin which is connected to the first conductive plate or the second conductive plate in parallel to the short pin and in adjacent to the short pin.

The antenna element includes: a fifth conductive plate which is placed at a position opposed to the fourth conductive plate across the first conductive plate and the second conductive plate, and which shares one sides of the first conductive plate and the second conductive plate; a ninth conductive plate and the tenth conductive plate which extend respectively from two adjacent sides of the fifth conductive plate that do not share the one sides of the first conductive plate and the second conductive plate, and which are placed at about 90 degrees with respect to the fifth conductive plate; and slits which are disposed respectively between the ninth conductive plate and the tenth conductive plate, and the first conductive plate and the second conductive plate.

In the antenna element, one side of the sixth conductive plate is shared with one side of the seventh conductive plate to form an L-shaped folded portion.

In the antenna element, one side of the ninth conductive plate is shared with one side of the tenth conductive plate to form an L-shaped folded portion.

In the antenna element, the short pin and the feed pin are connected to the first conductive plate or the second conductive plate in a substantially middle in a width direction of the first conductive plate or the second conductive plate.

In the antenna element, the short pin and the feed pin are rectangular thin plates, and a length of one side in the width direction of the first conductive plate or the second conductive plate is equal to or smaller than a total of a width of the short pin, an interval between the short pin and the feed pin, and a width of the feed pin.

In the antenna element, the width of the short pin is equal to the width of the feed pin.

In the antenna element, the sixth conductive plate or the seventh conductive plate is formed into a meander shape by a strip line.

In the antenna element, the ninth conductive plate or the tenth conductive plate is formed into a meander shape by a strip line.

In the antenna element, a space formed by the first conductive plate, the second conductive plate, and the fourth conductive plate is filled with a dielectric material or a magnetic material.

The invention provides an antenna element comprising: a second conductive plate which is placed with being separated from a ground plate by a predetermined interval, and which is approximately rectangular; a fourth conductive plate which shares one side of the second conductive plate, the one side being separated from the ground plate, and which is placed at about 90 degrees with respect to the second conductive plate; a sixth conductive plate, a seventh conductive plate, and an eighth conductive plate which extend respectively from three sides of the fourth conductive plate that do not share the one side of the second conductive plate, which are placed at about 90 degrees with respect to the fourth conductive plate, and which share respectively adjacent sides to form a U-shaped folded portion; slits which are disposed between the sixth conductive plate, the seventh conductive plate, and the eighth conductive plate, and the second conductive plate; a short pin which connects the ground plate to the second conductive plate; and a feed pin which is connected to the second conductive plate in parallel to the short pin and in adjacent to the short pin.

The antenna element includes: a fifth conductive plate which is placed at a position opposed to the fourth conductive plate across the second conductive plate, and which shares one side of the second conductive plate; a ninth conductive plate, a tenth conductive plate, and an eleventh conductive plate which extend respectively from three sides of the fifth conductive plate that do not share the one side of the second conductive plate, which are placed at about 90 degrees with respect to the fifth conductive plate, and which share respectively adjacent sides to form a U-shaped folded portion; and slits which are disposed respectively between the ninth conductive plate, the tenth conductive plate, and the eleventh conductive plate, and the second conductive plate.

In the antenna element, the short pin and the feed pin are connected to the second conductive plate in a substantially middle in a width direction of the second conductive plate.

In the antenna element, the short pin and the feed pin are rectangular thin plates, and a length of one side in the width direction of the second conductive plate is equal to or smaller than a total of a width of the short pin, an interval between the short pin and the feed pin, and a width of the feed pin.

In the antenna element, the width of the short pin is equal to the width of the feed pin.

In the antenna element, the sixth conductive plate, the seventh conductive plate, or the eighth conductive plate is formed into a meander shape by a strip line.

In the antenna element, the ninth conductive plate, the tenth conductive plate, or the eleventh conductive plate is formed into a meander shape by a strip line.

In the antenna element, a space formed by the second conductive plate, the fourth conductive plate, the sixth conductive plate, the seventh conductive plate, and the eighth conductive plate is filled with a dielectric material or a magnetic material.

### EFFECTS OF THE INVENTION

According to the antenna element of the invention, the size is small, the gain is high, the band can be wider, and the antenna element can cope with multiband transmission.

### BRIEF DESCRIPTION OF THE DRAWINGS

FIG. 1 is a perspective view showing an antenna element of a planar monopole antenna.

FIG. 2 is a perspective view showing an antenna element of a box monopole antenna.

FIG. 3 is a graph showing the VSWR characteristics of the antenna element of the planar monopole antenna.

FIG. 4 is a graph showing the VSWR characteristics of the antenna element of the box monopole antenna.

FIG. 5 is a perspective view showing an antenna element of a box monopole antenna in which a short pin is disposed.

FIG. 6 is a graph showing the VSWR characteristics of the antenna element of the box monopole antenna in which a short pin is disposed.

FIG. 7 is a perspective view showing an antenna element of a first embodiment.

FIG. 8 is a graph showing the VSWR characteristics of the antenna element of the first embodiment in the case where a feed pin and a short pin have a width of 6 mm.

FIG. 9 is a graph showing the VSWR characteristics of the antenna element of the first embodiment in the case where the feed pin and the short pin have a width of 3 mm.

FIG. 10 is a perspective view showing an antenna element of another embodiment.

FIG. 11(a) is a graph showing the VSWR characteristics of the antenna element shown in FIG. 10, and FIG. 11(b) is a graph showing the VSWR characteristics of the antenna element of the first embodiment.

FIGS. 12(a) and (b) are views showing a section of an antenna element in which a first antenna element has a box-like shape.

FIGS. 13(a) and (b) are perspective views showing a modification of the antenna element of the first embodiment.

FIGS. 14(a), (b) and (c) are perspective views showing a modification of the antenna element of the first embodiment.

FIG. 15 is a view showing the antenna element of the first embodiment shown in FIG. 7 in which a second antenna element has a meander structure.

FIG. 16 is a perspective view showing an antenna element of a second embodiment.

FIG. 17 is a graph showing the VSWR characteristics of the antenna element of the second embodiment.

FIG. 18 is a perspective view showing an antenna element of a third embodiment.

FIG. 19 is a perspective view showing a modification of the antenna element of the third embodiment.

FIG. 20 is a perspective view showing a modification of the antenna element of the third embodiment.

FIG. 21 is a perspective view showing a modification of the antenna element of the third embodiment.

FIG. 22 is a perspective view showing an antenna element of a fourth embodiment.

FIG. 23 is a perspective view showing a modification of the antenna element of the fourth embodiment.

FIG. 24 is a perspective view of a rectangular parallelepiped antenna element which is disclosed in Patent Reference 1.

FIG. 25 is an external view showing an antenna chip in which an antenna element of Patent Reference 2 is formed.

FIGS. 26(a) and (b) have a view abstractly showing the structure of an antenna of Patent Reference 3.

### DESCRIPTION OF REFERENCE NUMERALS AND SIGNS

51 first conductive plate
52 second conductive plate
53 third conductive plate
54 fourth conductive plate
55 fifth conductive plate
56, 56′ sixth conductive plate
57, 57′ seventh conductive plate
58 eighth conductive plate
59 ninth conductive plate
61, 61′ feed pin
63, 63′ short pin
75 feed point
71 printed board

### BEST MODE FOR CARRYING OUT THE INVENTION

Hereinafter, embodiments of the invention will be described with reference to the drawings.

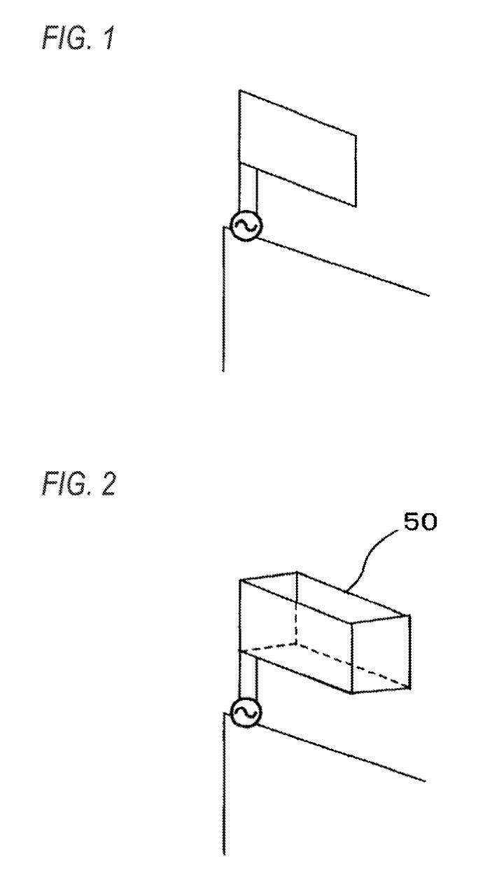

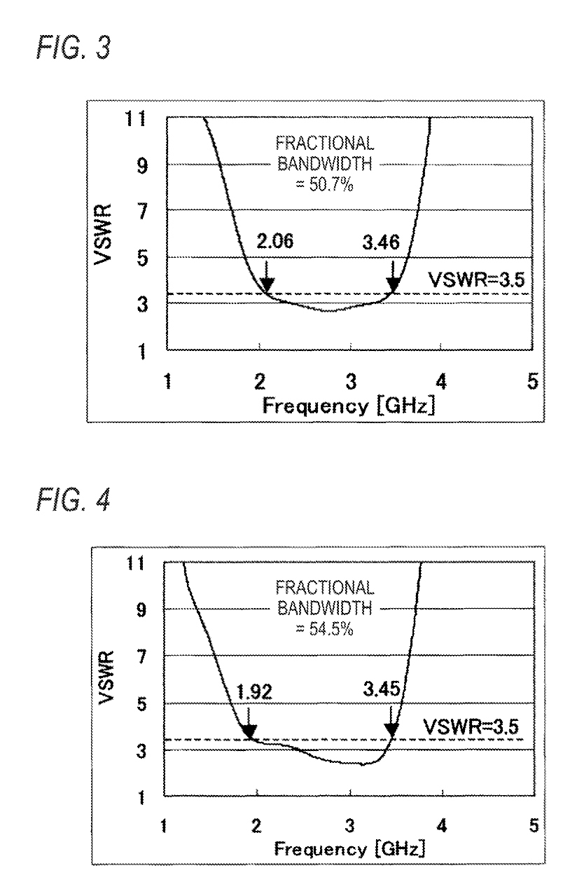

FIG. 1 shows a planar monopole antenna which is fed at an end of a ground plane, and which has a thickness of 0.5 mm, and FIG. 2 shows a box monopole antenna 50 which is placed at a similar position, and in which the external shape configured by five conductor faces has a rectangular parallelepiped shape. The external shape of the box monopole antenna has a thickness of 2.0 mm, and the antenna is placed in a direction in which only one face that is upward directed in the case where the ground side is placed on the lower side is not provided with a conductive plate. The effects of the invention will be shown by comparing the characteristics of the monopole antenna having a basic shape by using the following simulation results. FIG. 3 is a graph showing the VSWR characteristics of the antenna element of the planar monopole antenna, and FIG. 4 is a graph showing the VSWR characteristics of the antenna element of the box monopole antenna.

As shown in FIG. 3, when the antenna element is a planar monopole antenna, the frequency band of VSWR≦3.5 is from 2.06 GHz to 3.46 GHz, and the fractional bandwidth is about 50.7%. As shown in FIG. 4, when the antenna element is a box monopole antenna, by contrast, the frequency band of VSWR≦3.5 is from 1.92 GHz to 3.45 GHz, and the fractional bandwidth in which the bandwidth is indicated by the center frequency of the corresponding band is about 54.5%. In this way, when an antenna element is formed into a pentahedron box-like shape, it is expected to obtain an effect of wider bandwidth of the fractional bandwidth. In an antenna element having a box-like shape, however, a particular effect cannot be obtained in the viewpoint of the mounting area.

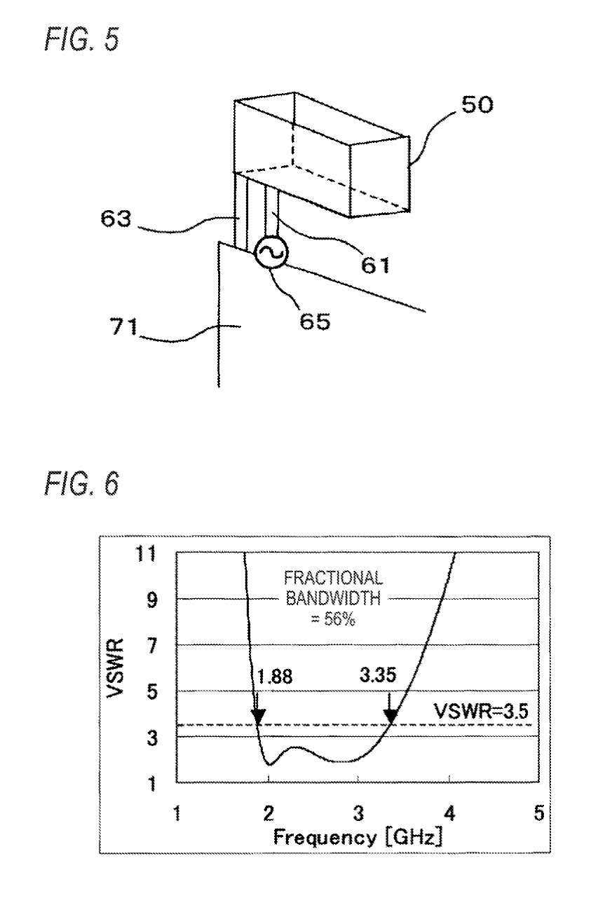

Next, two kinds of antenna elements will be compared with each other. In an antenna element shown in FIG. 5, a feed pin 61 is disposed in the box monopole antenna 50, and a short pin 63 is disposed in adjacent to the feed pin 61 to form an inverted F antenna (PIFA: planar inverted F antenna) feeding structure. Generally, an inverted F antenna includes a planar element, and has a feature that the antenna can be configured as a low-profile with respect to the ground surface, and a linear inverted F antenna has a narrow band. In this study, a linear inverted F antenna is configured by a box-like shape to obtain a new effect. The short pin 63 is a rectangular thin plate which connects the ground surface of a printed board 71 to the monopole antenna 50, and disposed in parallel to the feed pin 61. FIG. 6 is a graph showing the VSWR characteristics of an antenna element having a short pin.

As shown in FIG. 6, when the antenna element of the box monopole antenna has the short pin 63, the frequency band of VSWR≦3.5 is from 1.88 GHz to 3.35 GHz, and the fractional bandwidth is about 56%. These characteristics are equivalent to those in the case of a monopole antenna, and, also when the inverted F feeding is performed on a box antenna, it is expected to obtain a similar effect of wider bandwidth.

### First Embodiment

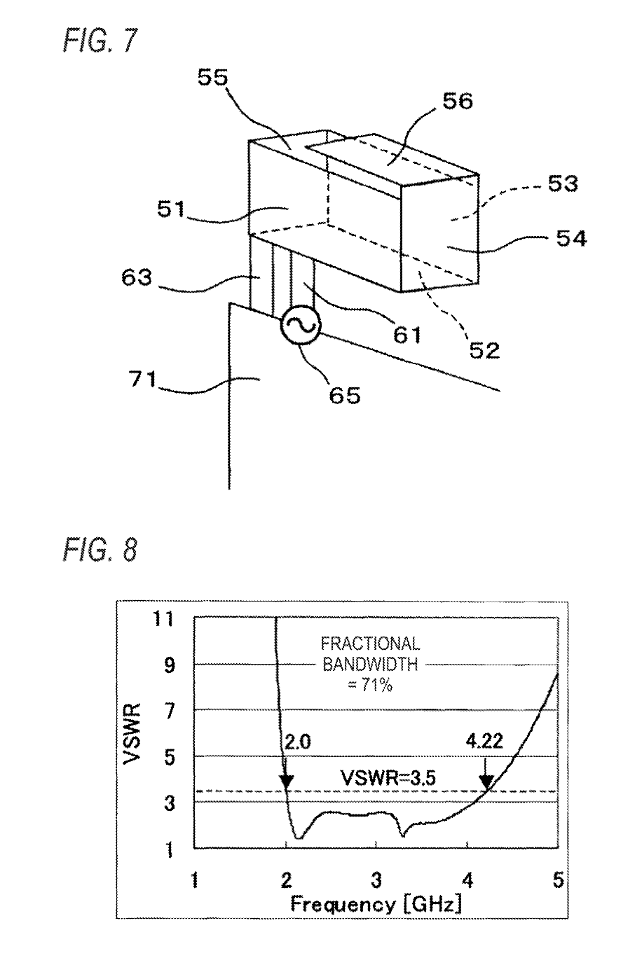

Hereinafter, an antenna element of a first embodiment which is different from the above-described planar or pentahedron box antenna element will be described. FIG. 7 is a perspective view showing the antenna element of the first embodiment. As shown in FIG. 7, the antenna element of the first embodiment includes a first conductive plate 51, a second conductive plate 52, a third conductive plate 53, a fourth conductive plate 54, a fifth conductive plate 55, a sixth conductive plate 56, a feed pin 61, and a short pin 63.

The first conductive plate 51 is a substantially rectangular thin conductor which is placed with being separated from a ground plate by a predetermined interval. For example, the long side is 24 mm in length, and the short side is 5 mm in length. The first conductive plate 51 and the second conductive plate 52 share one side (long side) in the width direction, and are placed in a state where they are bent at an angle of about 90 degrees. The second conductive plate 52 is a substantially rectangular thin conductor, shares one side of the first conductive plate 51 in the width direction, and is placed while being bent at about 90 degrees with respect to (the surface direction of) the first conductive plate 51.

The third conductive plate 53 is a substantially rectangular thin conductor, shares one of two sides (long sides) of the second conductive plate 52 in the width direction, the one side being not shared with the first conductive plate 51, is placed in a state where it is bent at an angle of about 90 degrees. The third conductive plate 53 is placed in a state where it is bent at an angle of about 90 degrees with respect to the second conductive plate 52, so as to be opposed to the first conductive plate 51.

The fourth conductive plate 54 is a substantially rectangular thin conductor, and shares sides (three sides) with respective one sides (short sides) of the first conductive plate 51, the second conductive plate 52, and the third conductive plate 53. The fourth conductive plate 54 is disposed on the end face which is separated from a feed point 65.

The fifth conductive plate 55 is a substantially rectangular thin conductor, and shares sides (three sides) with respective one sides (short sides) of the first conductive plate 51, the second conductive plate 52, and the third conductive plate 53. The fifth conductive plate 55 is disposed on the end face which is close to the feed point 65.

The sixth conductive plate 56 is a substantially rectangular thin conductor, extends from one side of the fourth conductive plate 54 which does not share one sides of the first conductive plate 51, the second conductive plate 52, and the third conductive plate 53, and is placed in a state where it is bent at about 90 degrees with respect to the fourth conductive plate 54. The both side ends of the sixth conductive plate 56 are not coupled to the first conductive plate 51 and the third conductive plate 53, and slit-like gaps (hereinafter, referred to as “slits”) are disposed between the sixth conductive plate 56, and the first conductive plate 51 and the third conductive plate 53. Also an end portion of the sixth conductive plate 56 which is opposite to the fourth conductive plate 54 is not coupled to the fifth conductive plate 55.

The feed pin 61 and the short pin 63 are rectangular thin plates, and placed in parallel to each other with being separated by a predetermined interval. In the embodiment, the feed pin 61 and the short pin 63 are disposed in a corner of the printed board 71. A power is fed from the feed point 65 to the first conductive plate 51 through the feed pin 61. The first conductive plate 51 is connected to the ground surface of the printed board 71 through the short pin 63.

As the widths of the feed pin 61 and the short pin 63 are larger, a larger current flows through the ground surface of the printed board 71, and hence the band of the antenna element is broadened. When the width of the feed pin 61 is made equal to that of the short pin 63, broadband matching is easily attained. When a current is aggressively flown not only through the first to sixth conductive plates but also through the ground surface formed by a conductor, namely, the bandwidth is broadened, and hence the band of the antenna element is broadened. When a large current flows to the ground side, however, the antenna element may be adversely influenced from the viewpoint of design. Preferably, therefore, an antenna element is caused to cope with the required band by adjusting the antenna element.

Furthermore, the interval between the feed pin 61 and the short pin 63 affects the resonant frequency of the antenna element configured by the first to fifth conductive plates 51 to 55. The resonant frequency of the antenna element configured by the sixth conductive plate 56 is affected by the length of the sixth conductive plate 56 which extends from the fourth conductive plate 54.

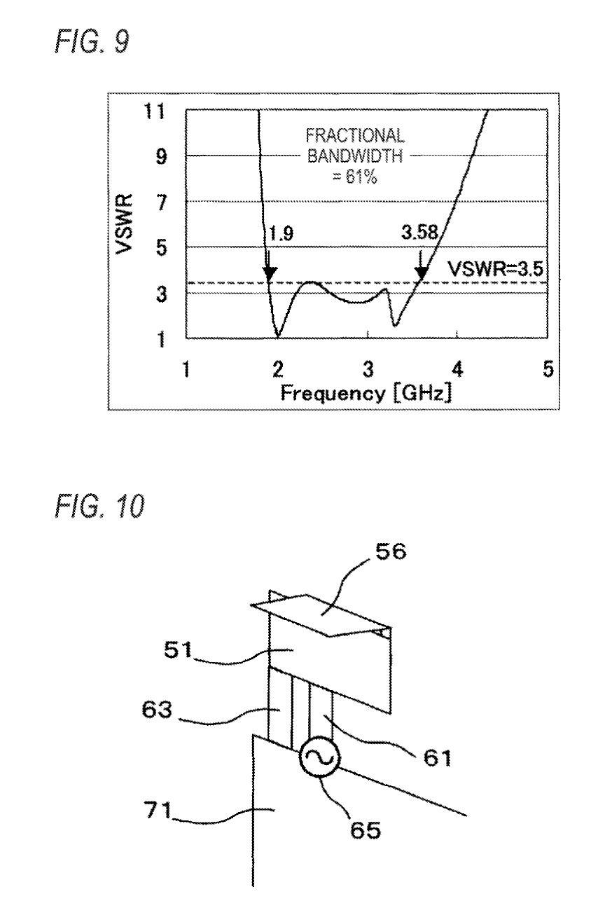

When a pentahedron configured by the first to fifth conductive plates 51 to 55 is set as a first antenna element, and the sixth conductive plate 56 is set as a second antenna element, the first antenna element has broadband characteristics having various current distributions, and the second antenna element resonates in a specific band. FIGS. 8 and 9 are graphs showing the VSWR characteristics of the antenna element of the first embodiment. The graph of FIG. 8 shows the case where the feed pin 61 and the short pin 63 have a width of 6 mm, and that of FIG. 9 shows the case where the feed pin 61 and the short pin 63 have a width of 3 mm.

As shown in FIGS. 8 and 9, the first antenna element resonates in the 2 GHz band, and exhibits broadband characteristics. By contrast, the second antenna element resonates in the vicinity of 3.3 GHz which is different from the resonant frequency of the first antenna element. In the graph shown in FIG. 8, the frequency band of VSWR≦3.5 is from 2.0 GHz to 4.22 GHz, and the fractional bandwidth is about 71%. In the graph shown in FIG. 9, the frequency band of VSWR≦3.5 is from 1.9 GHz to 3.58 GHz, and the fractional bandwidth is about 61%. In this way, the widths of the feed pin 61 and the short pin 63 influence the respective bandwidths, and, as the pin width is larger, the band is broader so that broadband characteristics are easily obtained.

The sixth conductive plate 56 having a length of 16.1 mm has a dimension of λ/4 at about 4.5 GHz. As described above, however, the slits are disposed between the sixth conductive plate 56, and the first conductive plate 51 and the third conductive plate 53 are disposed, and hence a capacitance component is obtained between the second antenna element and the first antenna element, with the result that the resonant frequency due to the second antenna element is lowered by about 1 GHz. The slits have a width which is approximately at 0.02λ or less with respect to the resonant frequency λ of the second antenna element, or which is, for example, 0.5 mm.

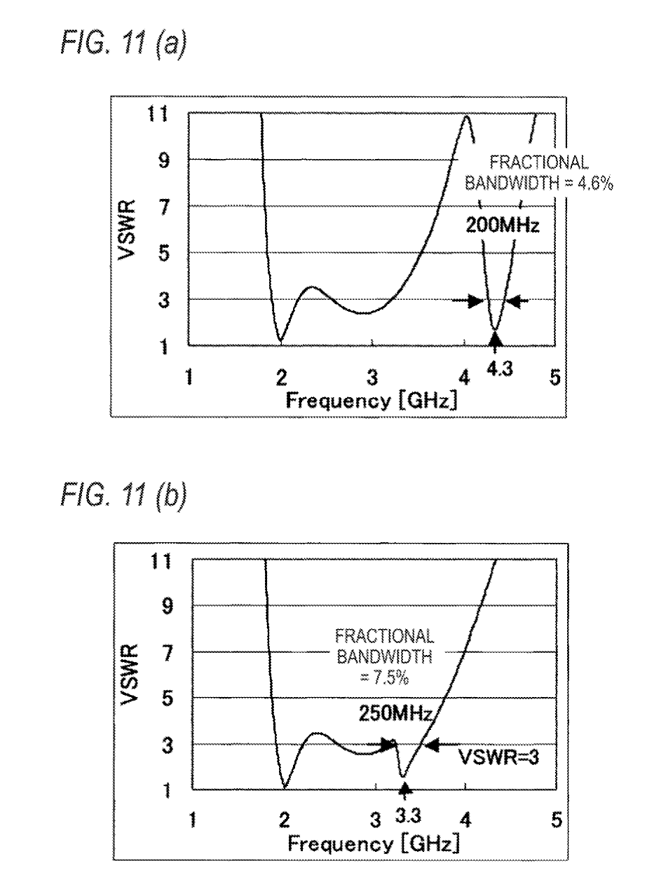

FIG. 10 shows a similar shape in which a simple folded element that is different from the embodiment is disposed, and which is configured by the same projection amount, or a configuration in which the first antenna element is configured only by the first conductive plate 51, and a slit is disposed between the sixth conductive plate 56 constituting the second antenna element, and the first conductive plate 51. FIG. 11(a) is a graph showing the VSWR characteristics of the antenna element shown in FIG. 10, and FIG. 11(b) is a graph showing the VSWR characteristics of the antenna element of the first embodiment. As shown in FIG. 11, in the antenna element shown in FIG. 10, the second antenna element resonates in the vicinity of 4.3 GHz, and, in the antenna element of the embodiment, the second antenna element resonates in the vicinity of 3.3 GHz. As described above, in the proposed structure in which the first antenna element has a pentahedron box-like shape and the slits are disposed with respect to the second antenna element, the resonant frequency of the second antenna element is largely lowered. This is very advantageous in realizing miniaturization which is required in an antenna. Also in the band, when the band in the second antenna element is compared, the fractional bandwidth, which was 4.6%, can be broadened to 7.5%.

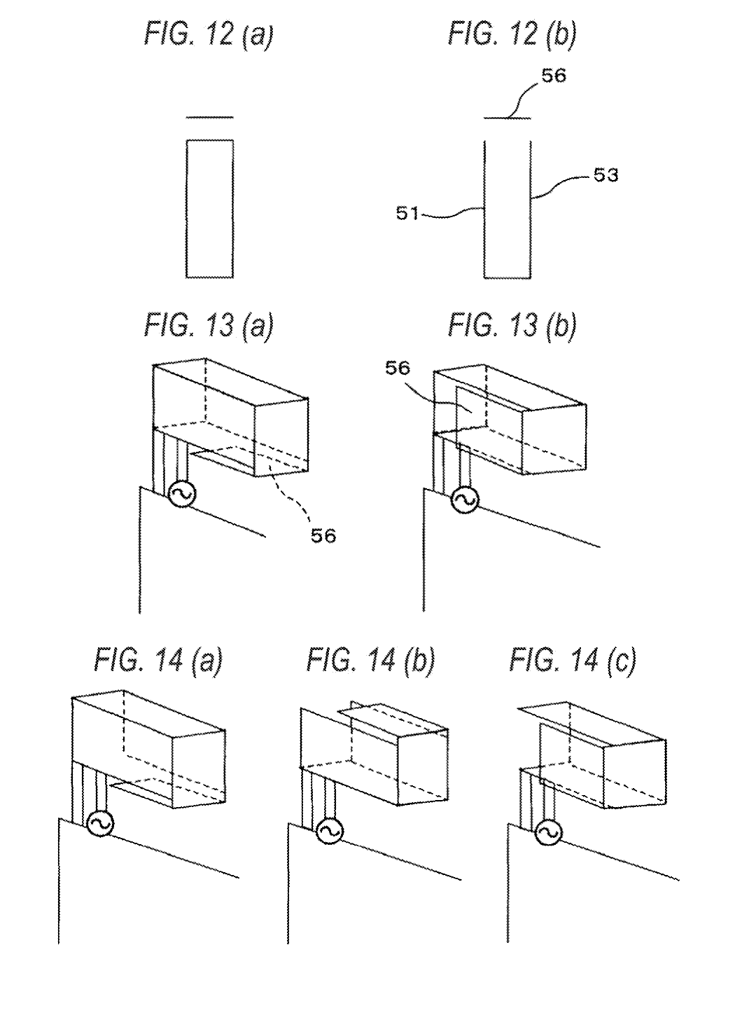

Even in the case where the first antenna element has a box-like shape, when the second antenna element is facially opposed to the first antenna element as shown in FIG. 12(a), currents flow through the opposed surfaces in a reversed phase relationship, and hence radiation due to the second antenna element is blocked. In the embodiment, by contrast, the second antenna element is not facially contacted with the first antenna element as shown in FIG. 12(b), and the slits are disposed between the second antenna element and the first antenna element. Since an adequate capacitance component is disposed in the slits, it is expected to exert double effects that the electrical length of the second antenna element can be prolonged, and that an adverse influence on radiation due to the reversed phase current can be reduced.

As described above, according to the embodiment, the first antenna element and the second antenna element have respective different resonant frequency bands, and the resonant frequency can be adjusted by adjusting the length of the sixth conductive plate 56 constituting the second antenna element, the widths of the feed pin 61 and the short pin 63, and the interval between the feed pin 61 and the short pin 63. Therefore, it is possible to provide an antenna element which can cope with band broadening and multiband transmission.

The first antenna element is not limited to a pentahedron box-like shape in which the upper face is opened. Alternatively, the element may have a shape in which the lower face is opened or a side face is opened as shown in FIG. 13. In this case, the sixth conductive plate 56 extends from the fourth conductive plate 54 toward the opened face. As shown in FIG. 14, the fifth conductive plate 55 is not always required to be disposed.

The feed pin 61 and the short pin 63 are not always required to be disposed in a corner of the printed board 71, and may be disposed in the middle of the printed board 71.

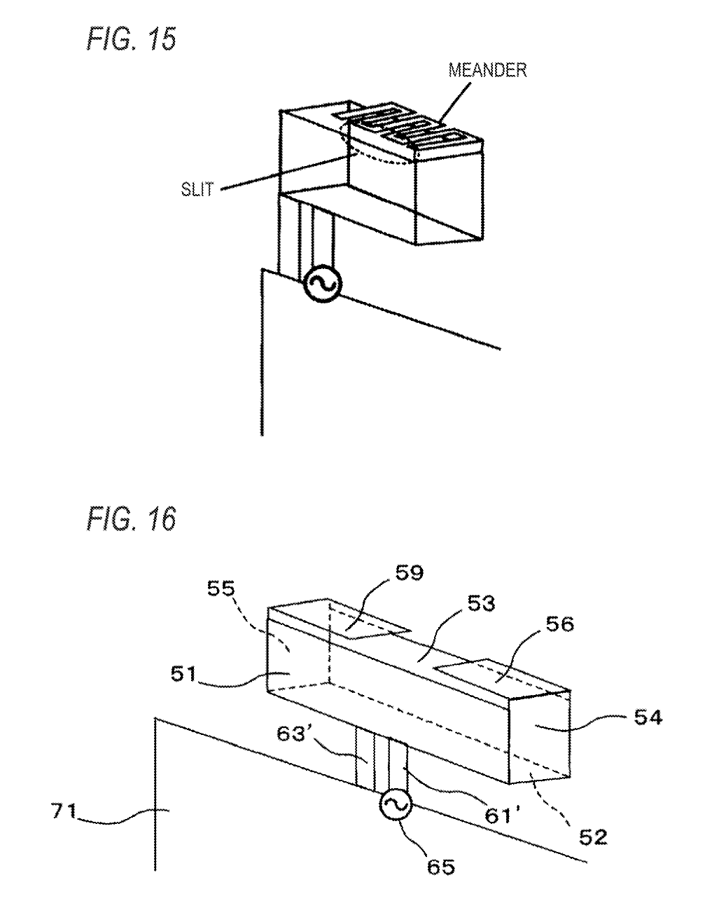

The conductive plate forming the second antenna element in the embodiment may be replaced with a meander structure in which the element length can be made electrically longer by a slender line path. FIG. 15 is a view showing the antenna element of the embodiment shown in FIG. 7 in which the second antenna element has a meander structure. When slits are disposed between the first conductive plate 51 and the third conductive plate 53, and a meander element as shown in FIG. 15, it is possible to obtain a resonant frequency which is lower than that in the case where the second antenna element is configured by a conductive plate. Therefore, flexibility in antenna element design is enhanced.

### Second Embodiment

An antenna element of a second element will be described. Among components constituting the antenna element of the second embodiment, components which are identical with those of the antenna element that has been described as the first embodiment are denoted by the same reference numerals, and duplicated description is omitted.

FIG. 16 is a perspective view showing the antenna element of the second embodiment. As shown in FIG. 16, the antenna element of the second embodiment includes the first conductive plate 51, the second conductive plate 52, the fourth conductive plate 54, the fifth conductive plate 55, the sixth conductive plate 56, a ninth conductive plate 59, a feed pin 61′, and a short pin 63′.

The ninth conductive plate 59 is a substantially rectangular thin conductor, extends from one side of the fifth conductive plate 55 which does not share one sides of the first conductive plate 51, the second conductive plate 52, and the third conductive plate 53, and is placed in a state where it is bent at about 90 degrees with respect to the fifth conductive plate 55. The both side ends of the ninth conductive plate 59 are not coupled to the first conductive plate 51 and the third conductive plate 53, and slit-like gaps (hereinafter, referred to as “slits”) are disposed between the ninth conductive plate 59, and the first conductive plate 51 and the third conductive plate 53. An end portion of the ninth conductive plate 59 which is opposite to the fifth conductive plate 55 is not coupled to the sixth conductive plate 56.

The feed pin 61′ and the short pin 63′ are rectangular thin plates, and placed in parallel to each other with being separated by a predetermined interval. In the embodiment, the feed pin 61′ and the short pin 63′ are disposed in a substantially middle of the printed board 71. A power is fed from the feed point 65 to the first conductive plate 51 through the feed pin 61′. The first conductive plate 51 is connected to the ground surface of the printed board 71 through the short pin 63′. Also in the embodiment, similarly with the first embodiment, the resonant frequency of the antenna element configured by the first to fifth conductive plates 51 to 55 can be adjusted by adjusting the widths of the feed pin 61′ and the short pin 63′, and the interval between the feed pin 61′ and the short pin 63′.

When a pentahedron configured by the first to fifth conductive plates 51 to 55 is set as a first antenna element, the sixth conductive plate 56 is set as a second antenna element, and the ninth conductive plate 59 is set as a third antenna element, the first antenna element has wideband characteristics having various current distributions, and the second antenna element and the third antenna element resonate in specific bands, respectively.

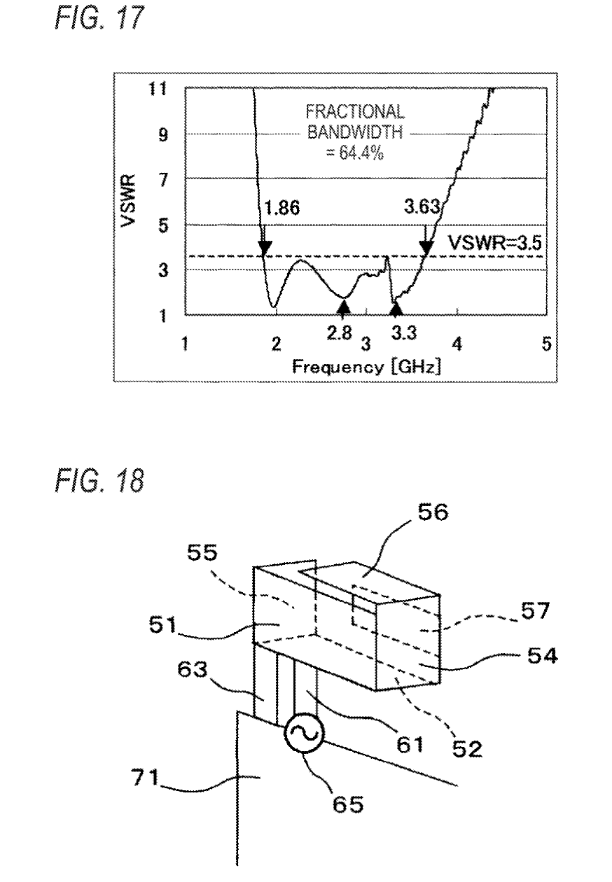

FIG. 17 is a graph showing the VSWR characteristics of the antenna element of the second embodiment. As shown in FIG. 17, the first antenna element resonates in the band in the vicinity of 1.9 GHz, the second antenna element resonates in the band in the vicinity of 3.3 GHz, and the third antenna element resonates in the band in the vicinity of 2.8 GHz. In the graph shown in FIG. 17, the frequency band of VSWR≦3.5 is from 1.86 GHz to 3.63 GHz, and the fractional bandwidth is about 64.4%.

In the embodiment, the length of the sixth conductive plate 56 which extends from the fourth conductive plate 54 is equal to that of the ninth conductive plate 59 which extends from the fifth conductive plate 55. However, the electrical lengths from the feed pin 61′ to the sixth conductive plate 56 and the ninth conductive plate 59 are different from each other. In the example shown in FIG. 16, therefore, the electrical length to the ninth conductive plate 59 which is the third antenna element is longer than the electric length to the sixth conductive plate 56 which is the second antenna element, and hence the third antenna element resonates at a lower frequency.

However, the length of the sixth conductive plate 56 is not necessary to be equal to that of the ninth conductive plate 59. When the lengths of the sixth conductive plate 56 and the ninth conductive plate 59 are different from each other, they resonate respectively at further different frequencies, and therefore it is possible to flexibly cope with multiband transmission.

As described above, according to the embodiment, the first antenna element, the second antenna element, and the third antenna element have respective different resonant frequency bands, and the resonant frequency can be adjusted by adjusting the length of the sixth conductive plate 56 constituting the second antenna element, that of the ninth conductive plate 59 constituting the third antenna element, the widths of the feed pin 61′ and the short pin 63′, and the interval between the feed pin 61′ and the short pin 63′. Therefore, it is possible to provide an antenna element which can cope with wider bandwidth and multiband transmission.

The first antenna element is not limited to a pentahedron box-like shape in which the upper face is opened. Alternatively, the element may have a shape in which the lower face is opened, or the side face is opened.

### Third Embodiment

In the embodiments described above, the second antenna element is configured by the single conductive plate. In the third embodiment, the second antenna element is configured by two conductive plates. FIG. 18 is a perspective view showing the antenna element of the third embodiment. As shown in FIG. 18, the antenna element of the third embodiment includes the first conductive plate 51, the second conductive plate 52, the fourth conductive plate 54, the fifth conductive plate 55, the sixth conductive plate 56, a seventh conductive plate 57, the feed pin 61, and the short pin 63. Among components constituting the antenna element of the third embodiment, components which are identical with those of the antenna element that has been described as the first embodiment are denoted by the same reference numerals, and duplicated description is omitted.

The seventh conductive plate 57 is a substantially rectangular thin conductor, extends from one of two adjacent sides of the fourth conductive plate 54 that does not share one sides of the first conductive plate 51 and the second conductive plate 52, and is placed in a state where it is bent at about 90 degrees with respect to the fourth conductive plate 54. The both side ends of the seventh conductive plate 57 are not coupled to the second conductive plate 52 and the sixth conductive plate 56, and slit-like gaps (hereinafter, referred to as “slits”) are disposed between the sixth conductive plate 56 and the first conductive plate 51, the sixth conductive plate 56 and the seventh conductive plate 57, and the seventh conductive plate 57 and the second conductive plate 52. Also an end portion of the seventh conductive plate 57 which is opposite to the fourth conductive plate 54 is not coupled to the fifth conductive plate 55.

In the embodiment, the first antenna element is configured by the first conductive plate 51, the second conductive plate 52, the fourth conductive plate 54, and the fifth conductive plate 55, the second antenna element is configured by the sixth conductive plate 56, and the third antenna element is configured by the seventh antenna element 57. According to the antenna element of the embodiment, the first antenna element has broadband characteristics having various current distributions, and the second antenna element and the third antenna element resonate in respective different specific bands.

According to the embodiment, the first antenna element, the second antenna element, and the third antenna element have respective different resonant frequency bands, and the resonant frequency can be adjusted by adjusting the length of the sixth conductive plate 56 constituting the second antenna element, and that of the seventh antenna element 57 constituting the third antenna element. Therefore, it is possible to provide an antenna element which can cope with wider bandwidth and multiband transmission.

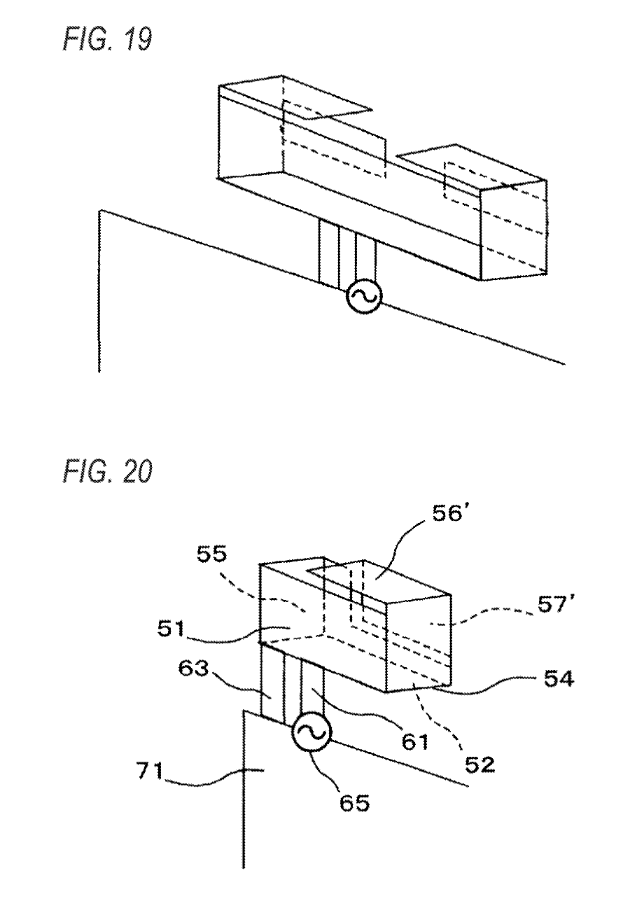

As a modification of the third embodiment, an antenna element shown in FIG. 19 may be configured similarly to the relationship between the first embodiment and the second embodiment. Namely, a fourth antenna element (a ninth conductive plate) and fifth antenna element (tenth conductive plate) corresponding to the second antenna element and the third antenna element may be disposed also on the side of the fifth conductive plate 55.

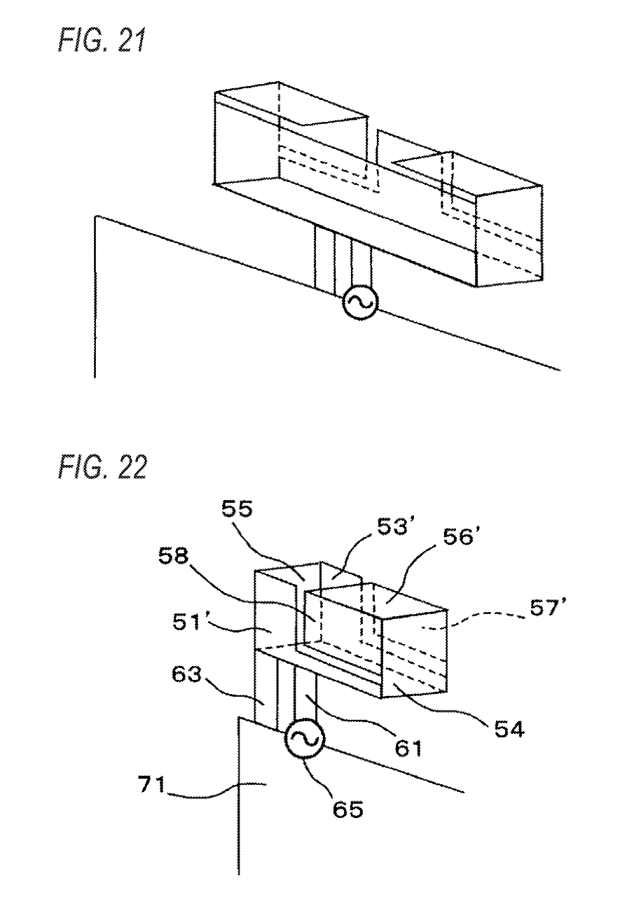

Furthermore, as a modification of the third embodiment, as shown in FIG. 20, sides of the sixth conductive plate 56 and the seventh conductive plate 57 which are adjacent to each other are coupled together, and a sixth conductive plate 56′ and seventh conductive plate 57′ having an L word-like section may be disposed as the second antenna element. When the area of the second antenna element is increased, the effect that the bandwidth is broadened by the second antenna element becomes remarkable. Similarly to the relationship between the first embodiment and the second embodiment, an antenna element shown in FIG. 21 may be configured. Namely, a third antenna element corresponding to the second antenna element may be disposed also on the side of the fifth conductive plate 55.

### Fourth Embodiment

In the third embodiment, the second antenna element is configured by two conductive plates. In the fourth element, the second antenna element is configured by three conductive plates. FIG. 22 is a perspective view showing the antenna element of the fourth embodiment. As shown in FIG. 22, the antenna element of the fourth embodiment includes a first conductive plate 51′, the second conductive plate 52, a third conductive plate 53′, the fourth conductive plate 54, the fifth conductive plate 55, a sixth conductive plate 56′, a seventh conductive plate 57′, an eighth conductive plate 58, the feed pin 61, and the short pin 63. The feed pin 61 and the short pin 63 are similar to those of the first embodiment.

The first conductive plate 51′ is an L word-like thin conductor which is placed with being separated from the ground plate by a predetermined interval. A long side of the outer circumference of the first conductive plate 51′, and one side (long side) of the second conductive plate 52 in the width direction are shared, and placed in a state where they are bent at an angle of about 90 degrees. The second conductive plate 52 is a substantially rectangular thin conductor, shares a long side of the outer circumference of the first conductive plate 51′, and is placed while being bent at about 90 degrees with respect to (the surface direction of) the first conductive plate 51′.

The third conductive plate 53′ is an L word-like thin conductor. A long side of the outer circumference of the third conductive plate 53′, and one of two sides (long sides) of the second conductive plate 52 in the width direction are shared, the one side being not shared with the first conductive plate 51′, and placed in a state where they are bent at an angle of about 90 degrees. The third conductive plate 53′ is placed in a state where it is bent at an angle of about 90 degrees with respect to the second conductive plate 52, so as to be opposed to the first conductive plate 51′.

The fourth conductive plate 54 is a substantially square thin conductor, and shares sides (three sides) with respective one sides (short sides) of the first conductive plate 51′, the second conductive plate 52, and the third conductive plate 53′. The fourth conductive plate 54 is disposed on the end face which is separated from the feed conductor 61.

The fifth conductive plate 55 is a substantially square thin conductor, and shares sides (three sides) with respective one sides (short sides) of the first conductive plate 51′, the second conductive plate 52, and the third conductive plate 53′. The fifth conductive plate 55 is disposed on the end face which is close to the feed conductor 61.

The sixth conductive plate 56′ is a substantially rectangular thin conductor, extends from one side of the fourth conductive plate 54 which does not share one sides of the first conductive plate 51′, the second conductive plate 52, and the third conductive plate 53′, and is placed in a state where it is bent at about 90 degrees with respect to the fourth conductive plate 54. The seventh conductive plate 57′ is a substantially rectangular thin conductor, extends from a side of the fourth conductive plate 54 which shares one side of the first conductive plate 51′, and is placed in a state where it is bent at about 90 degrees with respect to the fourth conductive plate 54. The eighth conductive plate 58 is a substantially rectangular thin conductor, extends from a side of the fourth conductive plate 54 which shares one side of the third conductive plate 53′, and is placed in a state where it is bent at about 90 degrees with respect to the fourth conductive plate 54.

The sixth conductive plate 56′, the seventh conductive plate 57′, and the eighth conductive plate 58 constitute a second antenna element which shares adjacent long sides, and which has a U-like section. The end of the eighth conductive plate 58 on the side of the first conductive plate 51′ is not coupled to the first conductive plate 51′, and slit-like gaps (hereinafter, referred to as “slits”) are disposed between the eighth conductive plate 58 and the first conductive plate 51′. The end of the seventh conductive plate 57′ on the side of the third conductive plate 53′ is not coupled to the third conductive plate 53′, and a slit is disposed between the seventh conductive plate 57′ and the third conductive plate 53′. Also end portions of the sixth conductive plate 56′, the seventh conductive plate 57′, and the eighth conductive plate 58 which are opposite to the fourth conductive plate 54 are not coupled to the fifth conductive plate 55.

In the embodiment, the first antenna element is configured by the first conductive plate 51′, the second conductive plate 52, the third conductive plate 53′, the fourth conductive plate 54, and the fifth conductive plate 55, and the second antenna element is configured by the sixth conductive plate 56′, the seventh conductive plate 57′, and the eighth conductive plate 58. According to the antenna element of the embodiment, the first antenna element has wideband characteristics having various current distributions, and the second antenna element resonates in a specific band.

According to the embodiment, the first antenna element and the second antenna element have respective different resonant frequency bands, and the bandwidth of the resonant frequency can be adjusted by adjusting the surface area of the second antenna element by adjusting the lengths of the sixth conductive plate 56′, seventh antenna element 57′, and eighth conductive plate 58 which constitute the second antenna element. Therefore, it is possible to provide an antenna element which can cope with wider bandwidth and multiband transmission.

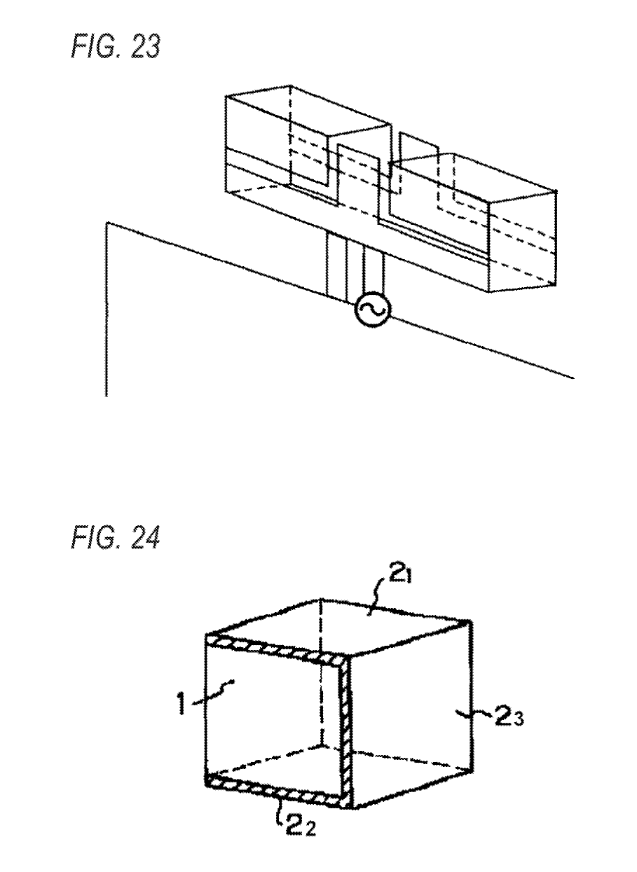

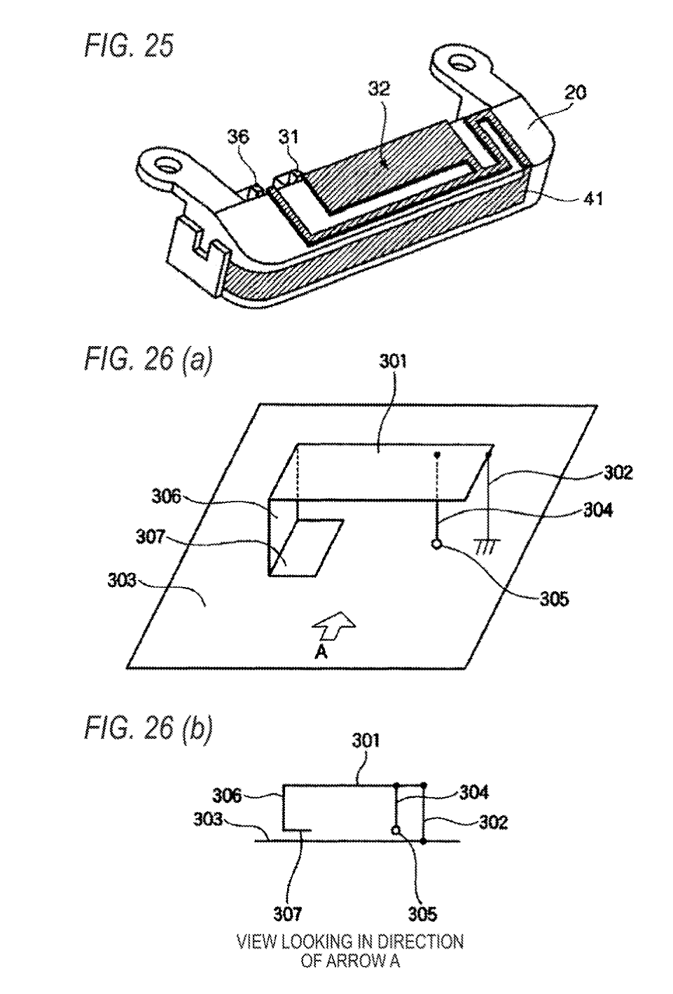

As a modification of the fourth embodiment, an antenna element shown in FIG. 23 may be configured similarly to the relationship between the first embodiment and the second embodiment. Namely, a third antenna element (a ninth conductive plate, a tenth conductive plate, and an eleventh conductive plate) corresponding to the second antenna element may be disposed also on the side of the fifth conductive plate 55.

Although the invention has been described in detail and with reference to the specific embodiments, it is obvious to those skilled in the art that various changes and modifications can be made without departing from the spirit and scope of the invention.

The application is based on Japanese Patent Application (Japanese patent application No. 2008-061307) filed on Mar. 11, 2008, and a subject matter of which is incorporated herein by reference.

### INDUSTRIAL APPLICABILITY

The antenna element of the invention is suitable for use in a plurality of radio systems to which a function such as GPS or Bluetooth can be added, and preferably applied to an antenna of, for example, a portable radio device such as a portable telephone or a PDA.

1. An antenna element comprising:
a first conductive plate which is placed with being separated from a ground plate by a predetermined interval, and which is approximately rectangular;
a second conductive plate which shares one side of the first conductive plate in a width direction, which is placed at about 90 degrees with respect to the first conductive plate, and which is approximately rectangular;
a third conductive plate which shares another side of the second conductive plate in the width direction, the another side being opposed to the one side shared with the first conductive plate, which is placed at about 90 degrees so as to be opposed to the first conductive plate, and which is approximately rectangular;
a fourth conductive plate which shares one sides of the first conductive plate, the second conductive plate, and the third conductive plate;
a sixth conductive plate which extends from one side of the fourth conductive plate that does not share the one sides of the first conductive plate, the second conductive plate, and the third conductive plate, and which is placed at about 90 degrees with respect to the fourth conductive plate;
slits which are disposed respectively between the sixth conductive plate, and the first conductive plate and the third conductive plate;
a short pin which connects the ground plate to the first conductive plate or the second conductive plate; and
a feed pin which is connected to the first conductive plate or the second conductive plate in parallel to the short pin and in adjacent to the short pin.

2. The antenna element according to claim 1, further comprising:
a fifth conductive plate which is placed at a position opposed to the fourth conductive plate across the first conductive plate, the second conductive plate, and the third conductive plate, and which shares one sides of the first conductive plate, the second conductive plate, and the third conductive plate;
a ninth conductive plate which extends from one side of the fifth conductive plate that does not share the one sides of the first conductive plate, the second conductive plate, and the third conductive plate, and which is placed at about 90 degrees with respect to the fifth conductive plate; and
slits which are disposed respectively between the ninth conductive plate, and the first conductive plate and the third conductive plate.

3. The antenna element according to claim 2, wherein the short pin and the feed pin are connected to the first conductive plate or the second conductive plate in a substantially middle in a width direction of the first conductive plate or the second conductive plate.

4. The antenna element according to claim 1, wherein the short pin and the feed pin are rectangular thin plates; and
wherein a length of one side in the width direction of the first conductive plate or the second conductive plate is equal to or smaller than a total of a width of the short pin, an interval between the short pin and the feed pin, and a width of the feed pin.

5. The antenna element according to claim 4, wherein the width of the short pin is equal to the width of the feed pin.

6. The antenna element according to claim 1, wherein the sixth conductive plate is formed into a meander shape by a strip line.

7. The antenna element according to claim 2, wherein the ninth conductive plate is formed into a meander shape by a strip line.

8. The antenna element according to claim 1, wherein a space formed by the first conductive plate, the second conductive plate, the third conductive plate, and the fourth conductive plate is filled with a dielectric material or a magnetic material.

9. An antenna element comprising:
a first conductive plate which is placed with being separated from a ground plate by a predetermined interval, and which is approximately rectangular;
a second conductive plate which shares one side of the first conductive plate in a width direction, which is placed at about 90 degrees with respect to the first conductive plate, and which is approximately rectangular;
a fourth conductive plate which shares one sides of the first conductive plate and the second conductive plate;
a sixth conductive plate and seventh conductive plate which extend respectively from two adjacent sides of the fourth conductive plate that do not share the one sides of the first conductive plate and the second conductive plate, and which are placed at about 90 degrees with respect to the fourth conductive plate;
slits which are disposed respectively between the sixth conductive plate and the seventh conductive plate, and the first conductive plate and the second conductive plate;
a short pin which connects the ground plate to the first conductive plate or the second conductive plate; and
a feed pin which is connected to the first conductive plate or the second conductive plate in parallel to the short pin and in adjacent to the short pin.

10. The antenna element according to claim 9, further comprising:
a fifth conductive plate which is placed at a position opposed to the fourth conductive plate across the first conductive plate and the second conductive plate, and which shares one sides of the first conductive plate and the second conductive plate;
a ninth conductive plate and a tenth conductive plate which extend respectively from two adjacent sides of the fifth conductive plate that do not share the one sides of the first conductive plate and the second conductive plate, and which are placed at about 90 degrees with respect to the fifth conductive plate; and
slits which are disposed respectively between the ninth conductive plate and the tenth conductive plate, and the first conductive plate and the second conductive plate.

11. The antenna element according to claim 9, wherein one side of the sixth conductive plate is shared with one side of the seventh conductive plate to form an L-shaped folded portion.

12. The antenna element according to claim 10, wherein one side of the ninth conductive plate is shared with one side of the tenth conductive plate to form an L-shaped folded portion.

13. The antenna element according to claim 10, wherein the short pin and the feed pin are connected to the first conductive plate or the second conductive plate in a substantially middle in a width direction of the first conductive plate or the second conductive plate.

14. The antenna element according to claim 9, wherein the short pin and the feed pin are rectangular thin plates; and
wherein a length of one side in the width direction of the first conductive plate or the second conductive plate is equal to or smaller than a total of a width of the short pin, an interval between the short pin and the feed pin, and a width of the feed pin.

15. The antenna element according to claim 14, wherein the width of the short pin is equal to the width of the feed pin.

16. The antenna element according to claim 9, wherein the sixth conductive plate or the seventh conductive plate is formed into a meander shape by a string line.

17. The antenna element according to claim 10, wherein the ninth conductive plate or the tenth conductive plate is formed into a meander shape by a string line.

18. The antenna element according to claim 9, wherein a space formed by the first conductive plate, the second conductive plate, and the fourth conductive plate is filled with a dielectric material or a magnetic material.

19. An antenna element comprising:
a second conductive plate which is placed with being separated from a ground plate by a predetermined interval, and which is approximately rectangular;
a fourth conductive plate which shares one side of the second conductive plate, the one side being separated from the ground plate, and which is placed at about 90 degrees with respect to the second conductive plate;
a sixth conductive plate, a seventh conductive plate, and an eighth conductive plate which extend respectively from three sides of the fourth conductive plate that do not share the one side of the second conductive plate, which are placed at about 90 degrees with respect to the fourth conductive plate, and which share respectively adjacent sides to form a U-shaped folded portion;
slits which are disposed between the sixth conductive plate, the seventh conductive plate, and the eighth conductive plate, and the second conductive plate;
a short pin which connects the ground plate to the second conductive plate; and
a feed pin which is connected to the second conductive plate in parallel to the short pin and in adjacent to the short pin.

20. The antenna element according to claim 19, further comprising:
a fifth conductive plate which is placed at a position opposed to the fourth conductive plate across the second conductive plate, and which shares one side of the second conductive plate;
a ninth conductive plate, a tenth conductive plate, and an eleventh conductive plate which extend respectively from three sides of the fifth conductive plate that do not share the one side of the second conductive plate, which are placed at about 90 degrees with respect to the fifth conductive plate, and which share respectively adjacent sides to form a U-shaped folded portion; and
slits which are disposed respectively between the ninth conductive plate, the tenth conductive plate, and the eleventh conductive plate, and the second conductive plate.

21. The antenna element according to claim 19, wherein the short pin and the feed pin are connected to the second conductive plate in a substantially middle in a width direction of the second conductive plate.

22. The antenna element according to claim 19, wherein the short pin and the feed pin are rectangular thin plates; and
wherein a length of one side in the width direction of the second conductive plate is equal to or smaller than a total of a width of the short pin, an interval between the short pin and the feed pin, and a width of the feed pin.

23. The antenna element according to claim 22, wherein the width of the short pin is equal to the width of the feed pin.

24. The antenna element according to claim 19, wherein the sixth conductive plate, the seventh conductive plate, or the eighth conductive plate is formed into a meander shape by a strip line.

25. The antenna element according to claim 20, wherein the ninth conductive plate, the tenth conductive plate, or the eleventh conductive plate is formed into a meander shape by a strip line.

26. The antenna element according to claim 19, wherein a space formed by the second conductive plate, the fourth conductive plate, the sixth conductive plate, the seventh conductive plate, and the eighth conductive plate is filled with a dielectric material or a magnetic material.
